(19) United States
(12) Patent Application Publication
(10) Pub. No.: US 2025/0193661 A1
(43) Pub. Date: Jun. 12, 2025

(54) Methods for Edge Computing Client to Obtain and use Identifiers of User Equipment that Hosts Client

(71) Applicant: Telefonaktiebolaget LM Ericsson (publ), Stockholm (SE)

(72) Inventors: Ferhat Karakoc, Istanbul (TR); Wenliang Xu, Shanghai (CN)

(21) Appl. No.: 18/844,175

(22) PCT Filed: May 12, 2023
(86) PCT No.: PCT/EP2023/062696

§ 371 Date: Sep. 5, 2024

(30) Foreign Application Priority Data
May 16, 2022 (WO) PCT/CN2022/092968

(51) Int. Cl. H04W 12/06; H04W 12/084; H04W 12/72

(52) U.S. Cl. CPC H04W 12/06; H04W 12/084; H04W 12/72

(57) ABSTRACT

Embodiments include methods for a client (e.g., EEC) of an edge data network. Such methods include, during or after authentication and/or authorization of the client by a first server (e.g., ECS) of the edge data network, receiving from the first server an identifier (UE ID) of a user 5 equipment that hosts the client. Such methods include sending the UE ID to a second server (e.g., EES) of the edge data network, during authentication and/or authorization of the client by the second server. Other embodiments include complementary methods for the first and second servers, as well as clients (or UEs hosting same) and servers configured to perform such methods.

### TECHNICAL FIELD

The present application relates generally to the field of wireless communication networks, and more specifically to “edge computing” techniques that facilitate secure execution environments proximate to users and/or devices, rather than in centralized, public network clouds.

### BACKGROUND

Currently the fifth generation (5G) of cellular systems is being standardized within the Third-Generation Partnership Project (3GPP). 5G is developed for maximum flexibility to support multiple and substantially different use cases. These include enhanced mobile broadband (eMBB), machine type communications (MTC), ultra-reliable low latency communications (URLLC), side-link device-to-device (D2D), and several other use cases.

FIG. 1 illustrates a high-level view of an exemplary 5G network architecture, consisting of a Next Generation Radio Access Network (NG-RAN, 199) and a 5G Core (5GC, 198). The NG-RAN can include one or more gNodeB's (gNBs) connected to the 5GC via one or more NG interfaces, such as gNBs (100, 150) connected via respective interfaces (102, 152). More specifically, the gNBs can be connected to one or more Access and Mobility Management Functions (AMFs) in the 5GC via respective NG-C interfaces and to one or more User Plane Functions (UPFs) in 5GC via respective NG-U interfaces. Various other network functions (NFs) can be included in the 5GC, as described in more detail below.

In addition, the gNBs can be connected to each other via one or more Xn interfaces, such as Xn interface (140) between gNBs (100, 150). The radio technology for the NG-RAN is often referred to as “New Radio” (NR). With respect to the NR interface to UEs, each of the gNBs can support frequency division duplexing (FDD), time division duplexing (TDD), or a combination thereof. Each of the gNBs can serve a geographic coverage area including one or more cells and, in some cases, can also use various directional beams to provide coverage in the respective cells. In general, a DL “beam” is a coverage area of a network-transmitted reference signal (RS) that may be measured or monitored by a UE.

The NG-RAN is layered into a Radio Network Layer (RNL) and a Transport Network Layer (TNL). The NG-RAN architecture, i.e., the NG-RAN logical nodes and interfaces between them, is defined as part of the RNL. For each NG-RAN interface (NG, Xn, F1) the related TNL protocol and the functionality are specified. The TNL provides services for user plane transport and signaling transport.

The NG RAN logical nodes shown in FIG. 1 include a Central Unit (CU or gNB-CU, e.g., 110) and one or more Distributed Units (DU or gNB-DU, e.g., 120, 130). CUs are logical nodes that host higher-layer protocols and perform various gNB functions such controlling the operation of DUs. DUs are decentralized logical nodes that host lower layer protocols and can include, depending on the functional split option, various subsets of the gNB functions.

A gNB-CU connects to one or more gNB-DUs over respective F1 logical interfaces (e.g., 122 and 132 shown in FIG. 1). However, a gNB-DU can be connected to only a single gNB-CU. The gNB-CU and its connected gNB-DU(s) are only visible to other gNBs and the 5GC as a gNB. In other words, the F1 interface is not visible beyond gNB-CU.

Another change in 5G networks (e.g., in 5GC) is that traditional peer-to-peer interfaces and protocols found in earlier-generation networks are modified and/or replaced by a Service Based Architecture (SBA) in which Network Functions (NFs) provide one or more services to one or more service consumers. This can be done, for example, by Hyper Text Transfer Protocol/Representational State Transfer (HTTP/REST) application programming interfaces (APIs). In general, the various services are self-contained functionalities that can be changed and modified in an isolated manner without affecting other services. This SBA model also adopts principles like modularity, reusability, and self-containment of NFs, which can enable deployments to take advantage of the latest virtualization and software technologies.

Furthermore, the services are composed of various “service operations”, which are more granular divisions of the overall service functionality. The interactions between service consumers and producers can be of the type “request/response” or “subscribe/notify”. In the 5G SBA, network repository functions (NRF) allow every network function to discover the services offered by other network functions, and Data Storage Functions (DSF) allow every network function to store its context.

3GPP Rel-16 introduced a feature called authentication and key management for applications (AKMA) that is based on 3GPP user credentials in 5G, including the Internet of Things (IoT) use case. More specifically, AKMA leverages the user's AKA (Authentication and Key Agreement) credentials to bootstrap security between the UE and an application function (AF), which allows the UE to securely exchange data with an application server. The AKMA architecture can be considered an evolution of GBA (Generic Bootstrapping Architecture) specified for 5GC in 3GPP Rel-15 and is further specified in 3GPP TS 33.535 (v16.0.0).

It is expected that 5GC will support edge computing (EC), which enables operator and third-party services to be hosted close to a UE's access point of attachment. This can facilitate efficient service delivery through the reduced end-to-end latency and load on the transport network. The 5GC can select a user plane function (UPF) close to the UE and perform traffic steering from the UPF to the local data network via an N6 interface. Both UPF and N6 are discussed in more detail below.

3GPP TR 23.748 (v17.0.0) discusses architectural enhancements that may be needed to support EC in 5GC. In addition, 3GPP TR 33.839 (v0.7.0) discusses a study on security aspects for supporting EC in 5GC for Rel-17. Key issues discussed in 3GPP TR 33.839 include authentication, authorization, and transport security solutions for interfaces between clients and servers and for interfaces between different servers in an edge data network. These servers can include Edge Configuration Servers (ECS), Edge Enabler Servers (EES), and Edge Application Servers (EAS). Relevant clients include Edge Enabler Client (EEC), which can be regarded an application that runs on the UE and communicates with the ECS and EES. 3GPP TS 23.558 (v17.3.0) specifies an architecture for enabling Edge applications, which includes these clients and servers.

### SUMMARY

To consume services provided by ECS and EES, the EEC provides an identifier of the UE that hosts the EEC (e.g., UE ID). However, it is currently unclear and/or unspecified how the EEC can obtain the UE ID. If the EEC does not have the UE ID, this may inhibit the EEC from obtaining services provided by ECS or by EES, which is undesirable.

Accordingly, embodiments of the present disclosure address these and other problems, issues, and/or difficulties, thereby enabling the otherwise-advantageous deployment of EC solutions in relation to 5G networks.

Some embodiments of the present disclosure include methods (e.g., procedures) for a client (e.g., EEC) of an edge data network (e.g., 5G network).

These exemplary methods include, during or after authentication and/or authorization of the client by a first server of the edge data network, receiving from the first server an identifier (UE ID) of a user equipment that hosts the client. These exemplary methods also include sending the UE ID to a second server of the edge data network, during authentication and/or authorization of the client by the second server.

In some embodiments, the UE ID is included in an access token received from the first server and the access token including the UE ID is sent to the second server. In some of these embodiments, one of more of the following applies:
the access token is sent to the second server together with an indication that the access token includes the UE ID; and
the access token is received from the first server together with an indication that the access token includes the UE ID.

In other embodiments, the UE ID is received from the first server in a service provisioning response, which does not include an access token for the second server; and/or the UE ID is sent to the second server in a request that does not include an access token for the second server.

Other embodiments include complementary methods (e.g., procedures) for a first server (e.g., ECS) of an edge data network (e.g., 5G network).

These exemplary methods can include, during or after authentication and/or authorization, by the first server, of a client of the edge data network, obtaining an identifier (UE ID) of a user equipment that hosts the client. The exemplary method can include the operation of block 1020, where the first server can send the UE ID to the client, for authentication and/or authorization of the client by a second server of the edge data network.

In some embodiments, the UE ID is a generic public subscription identifier (GPSI) and is obtained based on one of the following:
an authentication and key management for applications (AKMA) procedure with a communication network coupled to the edge data network;
a generic bootstrapping architecture (GBA) procedure with the communication network; or
an IP address-to-GPSI translation.

In some embodiments, the UE ID is sent to the client in an access token for the second server. In some of these embodiments, the access token is included in a service provisioning response to the client. In some of these embodiments, the access token is sent to the client together with an indication that the access token includes the UE ID.

In other embodiments, the UE ID is sent to the client in a service provisioning response, which does not include an access token for the second server.

Other embodiments include complementary methods (e.g., procedures) for a second server (e.g., EES) of an edge data network (e.g., 5G network).

These exemplary methods include receiving, from a client of the edge data network, an identifier (UE ID) of a user equipment that hosts the client. The UE ID was provided to the client by a first server of the edge data network. These exemplary methods also include performing authentication and/or authorization of the client based on the received UE ID.

In some embodiments, the UE ID is received from the client in in access token for the second server, the access token is generated by the first server, and authentication and/or authorization of the client is performed based on the access token. In some of these embodiments, the access token is received from the client together with an indication that the access token includes the UE ID.

In other embodiments, the UE ID is received from the client in a request that does not include an access token for the second server.

In various embodiments, the client is an EEC, the first server is an ECS, and the second server is an EES. In various embodiments, the UE ID is a GPSI.

Other embodiments include clients and servers in or associated with an edge data network (or UEs, network nodes, or computing systems hosting the same) that are configured to perform the operations corresponding to any of the exemplary methods described herein. Other embodiments also include non-transitory, computer-readable media storing computer-executable instructions that, when executed by processing circuitry, configure such clients and servers to perform operations corresponding to any of the exemplary methods described herein.

These and other embodiments described herein can provide clear and unambiguous ways for EEC to obtain and use a UE ID (i.e., of the UE hosting EEC) for authentication and/or authorization, thereby facilitating security of EC applications over 3GPP networks (e.g., 5GC and NG-RAN).

These and other objects, features, and advantages of the present disclosure will become apparent upon reading the following Detailed Description in view of the Drawings briefly described below.

### BRIEF DESCRIPTION OF THE DRAWINGS

FIGS. 1-2 illustrate various aspects of an exemplary 5G network architecture.

FIG. 3 shows a diagram of an exemplary application-layer architecture supporting edge computing (EC) applications in a 5G network.

FIG. 4 shows a signaling diagram of a token-based procedure for authentication of an EEC by an ECS and an EES.

FIGS. 5-6 show signal flow diagrams of various token-based procedures for authentication of an EEC.

FIGS. 7-8 show signaling diagrams of procedures between an EEC, an ECS, and an EES, according to various embodiments of the present disclosure.

FIG. 9 shows an exemplary method (e.g., procedure) for a client of an edge data network, according to various embodiments of the present disclosure.

FIG. 10 shows an exemplary method (e.g., procedure) for a first server of an edge data network, according to various embodiments of the present disclosure.

FIG. 11 shows an exemplary method (e.g., procedure) for a second server of an edge data network, according to various embodiments of the present disclosure.

FIG. 12 shows a communication system according to various embodiments of the present disclosure.

FIG. 13 shows a UE according to various embodiments of the present disclosure.

FIG. 14 shows a network node according to various embodiments of the present disclosure.

FIG. 15 shows host computing system according to various embodiments of the present disclosure.

FIG. 16 is a block diagram of a virtualization environment in which functions implemented by some embodiments of the present disclosure may be virtualized.

FIG. 17 illustrates communication between a host computing system, a network node, and a UE via multiple connections, at least one of which is wireless, according to various embodiments of the present disclosure.

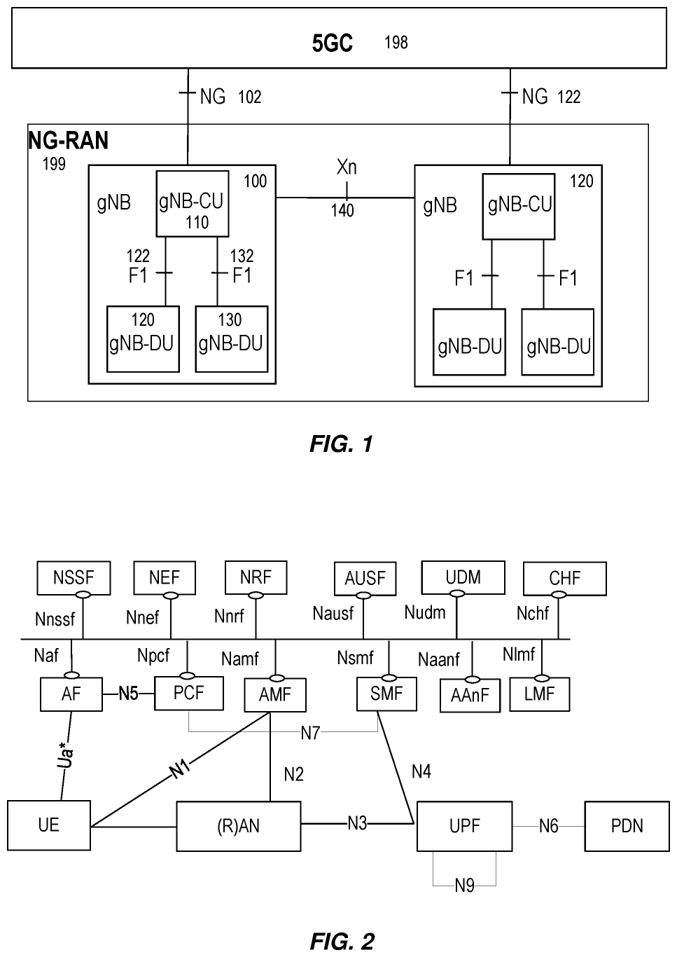

### DETAILED DESCRIPTION

Embodiments briefly summarized above will now be described more fully with reference to the accompanying drawings. These descriptions are provided by way of example to explain the subject matter to those skilled in the art and should not be construed as limiting the scope of the subject matter to only the embodiments described herein. More specifically, examples are provided below that illustrate the operation of various embodiments according to the advantages discussed above.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods and/or procedures disclosed herein do not have to be performed in the exact order disclosed, unless a step is explicitly described as following or preceding another step and/or where it is implicit that a step must follow or precede another step. Any feature of any of the embodiments disclosed herein can be applied to any other embodiment, wherever appropriate. Likewise, any advantage of any of the embodiments can apply to any other embodiments, and vice versa. Other objects, features, and advantages of the disclosed embodiments will be apparent from the following description.

Furthermore, the following terms are used throughout the description given below:
Radio Access Node: As used herein, a “radio access node” (or equivalently “radio network node,” “radio access network node,” or “RAN node”) can be any node in a radio access network (RAN) that operates to wirelessly transmit and/or receive signals. Some examples of a radio access node include, but are not limited to, a base station (e.g., gNB in a 3GPP 5G/NR network or an enhanced or eNB in a 3GPP LTE network), base station distributed components (e.g., CU and DU), a high-power or macro base station, a low-power base station (e.g., micro, pico, femto, or home base station, or the like), an integrated access backhaul (IAB) node, a transmission point (TP), a transmission reception point (TRP), a remote radio unit (RRU or RRH), and a relay node.
Core Network Node: As used herein, a “core network node” is any type of node in a core network. Some examples of a core network node include, e.g., a Mobility Management Entity (MME), a serving gateway (SGW), a PDN Gateway (P-GW), a Policy and Charging Rules Function (PCRF), an access and mobility management function (AMF), a session management function (SMF), a user plane function (UPF), a Charging Function (CHF), a Policy Control Function (PCF), an Authentication Server Function (AUSF), a location management function (LMF), or the like.
Wireless Device: As used herein, a “wireless device” (or “WD” for short) is any type of device that is capable, configured, arranged and/or operable to communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Unless otherwise noted, the term “wireless device” is used interchangeably herein with the term “user equipment” (or “UE” for short), with both of these terms having a different meaning than the term “network node”.
Radio Node: As used herein, a “radio node” can be either a “radio access node” (or equivalent term) or a “wireless device.”
Network Node: As used herein, a “network node” is any node that is either part of the radio access network (e.g., a radio access node or equivalent term) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.
Node: As used herein, the term “node” (without prefix) can be any type of node that can in or with a wireless network (including RAN and/or core network), including a radio access node (or equivalent term), core network node, or wireless device. However, the term “node” may be limited to a particular type (e.g., radio access node) based on its specific characteristics in any given context.

Note that the description given herein focuses on a 3GPP cellular communications system and, as such, 3GPP terminology or terminology similar to 3GPP terminology is generally used. However, the concepts disclosed herein are not limited to a 3GPP system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from the concepts, principles, and/or embodiments described herein.

In addition, functions and/or operations described herein as being performed by a wireless device or a network node may be distributed over a plurality of wireless devices and/or network nodes. Furthermore, although the term “cell” is used herein, it should be understood that (particularly with respect to 5G NR) beams may be used instead of cells and, as such, concepts described herein apply equally to both cells and beams.

FIG. 2 shows an exemplary non-roaming 5G reference architecture with service-based interfaces and various 3GPP-defined NFs within the Control Plane (CP). These include the following NFs, with additional details provided for those most relevant to the present disclosure:
Application Function (AF, with Naf interface) interacts with the 5GC to provision information to the network operator and to subscribe to certain events happening in operator's network. An AF offers applications for which service is delivered in a different layer (i.e., transport layer) than the one in which the service has been requested (i.e., signaling layer), the control of flow resources according to what has been negotiated with the network. An AF communicates dynamic session information to PCF (via N5 interface), including description of media to be delivered by transport layer.
Policy Control Function (PCF, with Npcf interface) supports unified policy framework to govern the network behavior, via providing PCC rules (e.g., on the treatment of each service data flow that is under PCC control) to the SMF via the N7 reference point. PCF provides policy control decisions and flow based charging control, including service data flow detection, gating, QoS, and flow-based charging (except credit management) towards the SMF. The PCF receives session and media related information from the AF and informs the AF of traffic (or user) plane events.
User Plane Function (UPF)—supports handling of user plane traffic based on the rules received from SMF, including packet inspection and different enforcement actions (e.g., event detection and reporting). UPFs communicate with the RAN (e.g., NG-RNA) via the N3 reference point, with SMFs (discussed below) via the N4 reference point, and with an external packet data network (PDN) via the N6 reference point. The N9 reference point is for communication between two UPFs.
Session Management Function (SMF, with Nsmf interface) interacts with the decoupled traffic (or user) plane, including creating, updating, and removing Protocol Data Unit (PDU) sessions and managing session context with the User Plane Function (UPF), e.g., for event reporting. For example, SMF performs data flow detection (based on filter definitions included in PCC rules), online and offline charging interactions, and policy enforcement.
Charging Function (CHF, with Nchf interface) is responsible for converged online charging and offline charging functionalities. It provides quota management (for online charging), re-authorization triggers, rating conditions, etc. and is notified about usage reports from the SMF. Quota management involves granting a specific number of units (e.g., bytes, seconds) for a service. CHF also interacts with billing systems.
Access and Mobility Management Function (AMF, with Namf interface) terminates the RAN CP interface and handles all mobility and connection management of UEs (similar to MME in EPC). AMFs communicate with UEs via the N1 reference point and with the RAN (e.g., NG-RAN) via the N2 reference point.
Network Exposure Function (NEF) with Nnef interface—acts as the entry point into operator's network, by securely exposing to AFs the network capabilities and events provided by 3GPP NFs and by providing ways for the AF to securely provide information to 3GPP network. For example, NEF provides a service that allows an AF to provision specific subscription data (e.g., expected UE behavior) for various UEs.
Network Repository Function (NRF) with Nnrf interface—provides service registration and discovery, enabling NFs to identify appropriate services available from other NFs.
Network Slice Selection Function (NSSF) with Nnssf interface—a “network slice” is a logical partition of a 5G network that provides specific network capabilities and characteristics, e.g., in support of a particular service. A network slice instance is a set of NF instances and the required network resources (e.g., compute, storage, communication) that provide the capabilities and characteristics of the network slice. The NSSF enables other NFs (e.g., AMF) to identify a network slice instance that is appropriate for a UE's desired service.
Authentication Server Function (AUSF) with Nausf interface—based in a user's home network (HPLMN), it performs user authentication and computes security key materials for various purposes.
Location Management Function (LMF) with Nlmf interface—supports various functions related to determination of UE locations, including location determination for a UE and obtaining any of the following: DL location measurements or a location estimate from the UE; UL location measurements from the NG RAN; and non-UE associated assistance data from the NG RAN.
Unified Data Management (UDM) function with Nudm interface—supports generation of 3GPP authentication credentials, user identification handling, access authorization based on subscription data, and other subscriber-related functions. To provide this functionality, the UDM uses subscription data (including authentication data) stored in the 5GC unified data repository (UDR), which also supports storage and retrieval of policy data by the PCF, as well as storage and retrieval of application data by NEF.

Communication links between the UE and a 5G network (AN and CN) can be grouped in two different strata. The UE communicates with the CN over the Non-Access Stratum (NAS), and with the AN over the Access Stratum (AS). All the NAS communication takes place between the UE and the AMF via the NAS protocol (N1 interface in FIG. 2). Security for the communications over this these strata is provided by the NAS protocol (for NAS) and the PDCP protocol (for AS).

3GPP Rel-16 introduces a new feature called authentication and key management for applications (AKMA) that is based on 3GPP user credentials in 5G, including the Internet of Things (IoT) use case. More specifically, AKMA leverages the user's AKA (Authentication and Key Agreement) credentials to bootstrap security between the UE and an application function (AF), which allows the UE to securely exchange data with an application server. The AKMA architecture is an evolution of Generic Bootstrapping Architecture (GBA) specified for 5GC in 3GPP Rel-15 and is further specified in 3GPP TS 33.535 (v16.1.0).

In addition to the NEF, AUSF, and AF shown in FIG. 2 and described above, Rel-16 AKMA also utilizes an anchor function for authentication and key management for applications (AAnF). This function is shown in FIG. 2 with Naanf interface. In general, AAnF interacts with AUSFs and maintains UE AKMA contexts to be used for subsequent bootstrapping requests, e.g., by application functions. At a high level, AAnF is similar to a bootstrapping server function (BSF) defined for Rel-15 GBA.

In general, security mechanisms for various 5GS protocols rely on multiple security keys. 3GPP TS 33.501 (v16.4.0) specifies these keys in an organized hierarchy. At the top is the long-term key part of the authentication credential and stored in the SIM card on the UE side and in the UDM/ARPF in the user's HPLMN.

A successful Primary Authentication run between the UE and the AUSF in the HPLMN leads to the establishment of K_{AUSF}, the second level key in the hierarchy. This key is not intended to leave the HPLMN and is used to secure the exchange of information between UE and HPLMN, such as for the provisioning of parameters to the UE from UDM in HPLMN. More precisely, K_{AUSF} is used for integrity protection of messages delivered from HPLMN to UE. As described in 3GPP TS 33.501, such new features include the Steering of Roaming (SoR) and the UDM parameter delivery procedures.

K_{AUSF} is used to derive another key, KSEAF, that is sent to the serving PLMN. This key is then used by the serving PLMN to derive subsequent NAS and AS protection keys. These lower-level keys together with other security parameters (e.g., cryptographic algorithms, UE security capabilities, value of counters used for replay protection in various protocols, etc.) constitute the 5G security context as defined in 3GPP TS 33.501. However, K_{AUSF} is not part of the UE's 5G security context that resides in the UE's serving PLMN.

3GPP TR 33.839 (v17.1.0) discusses a study on security aspects of enhancement of support for Edge Computing (EC) in 5GC for 3GPP Rel-17. Key issues discussed in 3GPP TR 33.839 include authentication, authorization, and transport security solutions for interfaces between clients and servers and for interfaces between different servers in an Edge data network. These servers can include Edge Configuration Servers (ECS), Edge Enabler Servers (EES), and Edge Application Servers (EAS). Relevant clients include Edge Enabler Client (EEC), which can be regarded as an application that runs on the UE and communicates with the ECS and EES.

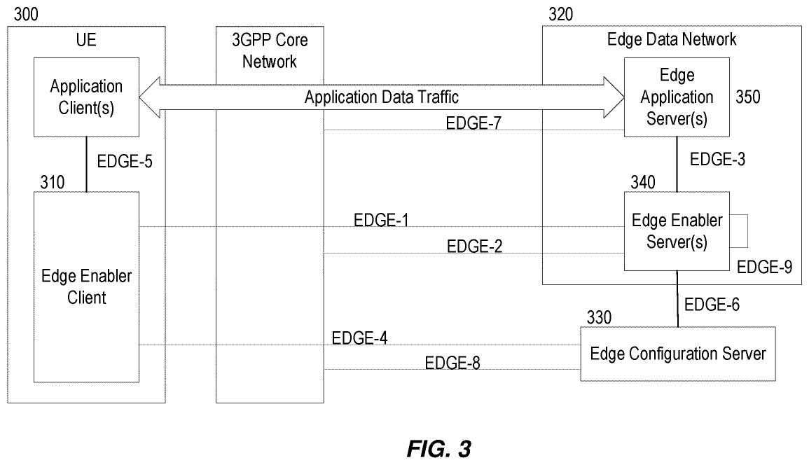

3GPP TS 23.558 (v17.3.0) specifies the various client/server and server/server interfaces in the Rel-17 EC architecture. FIG. 3 shows a diagram of an exemplary application-layer architecture supporting EC applications. In addition to the ECS (330), EES (340), EAS (350), and EEC (310) mentioned above, FIG. 3 also shows one or more application clients that run on the UE (300) and communicate application data traffic with the EAS in the Edge Data Network (320). Additionally, FIG. 3 shows the following client/server and server/server interfaces defined in 3GPP TS 23.558:
EDGE-1: between EEC and EES.
EDGE-2: between EES and CN (e.g., 5GC).
EDGE-3: between EAS and EES.
EDGE-4: between EEC and ECS.
EDGE-5: between EEC and application client(s).
EDGE-6: between ECS and EES.
EDGE-7: between EAS and CN.
EDGE-8: between ECS and CN.
EDGE-9: between EES and EES.
   Note that while FIG. 3 shows ECS (330) outside of the edge data network (300), this is an example representation. Due to its functionality, ECS can be considered as a part of the edge data network in a similar manner as the other servers shown.

In the architecture shown in FIG. 3, the EEC, which runs on the UE, needs to authenticate itself towards to the EES/ECS. The EEC provides a UE identifier (ID) for this purpose, as specified in 3GPP TS 23.558 section 7.2.6. One example UE ID is the generic public subscription identifier (GPSI), which can be used inside and outside of 5G networks as further specified in 3GPP TS 23.501 (v17.2.0) and 23.003 (v17.3.0). 3GPP TS 23.558 also specifies an edge enabler layer that includes the UE's EEC. In this arrangement, the UE uses an EEC ID as the client identifier on the edge enabler layer.

3GPP TS 33.558 (v17.0.0) specifies security and privacy mechanisms for the edge enabler layer specified in 3GPP TS 23.558. One of the security mechanisms is authorization of EEC by EES by use of access tokens. Specifically, ECS issues an access token for EEC to use towards EES, which authorizes EEC by verifying and checking the access token.

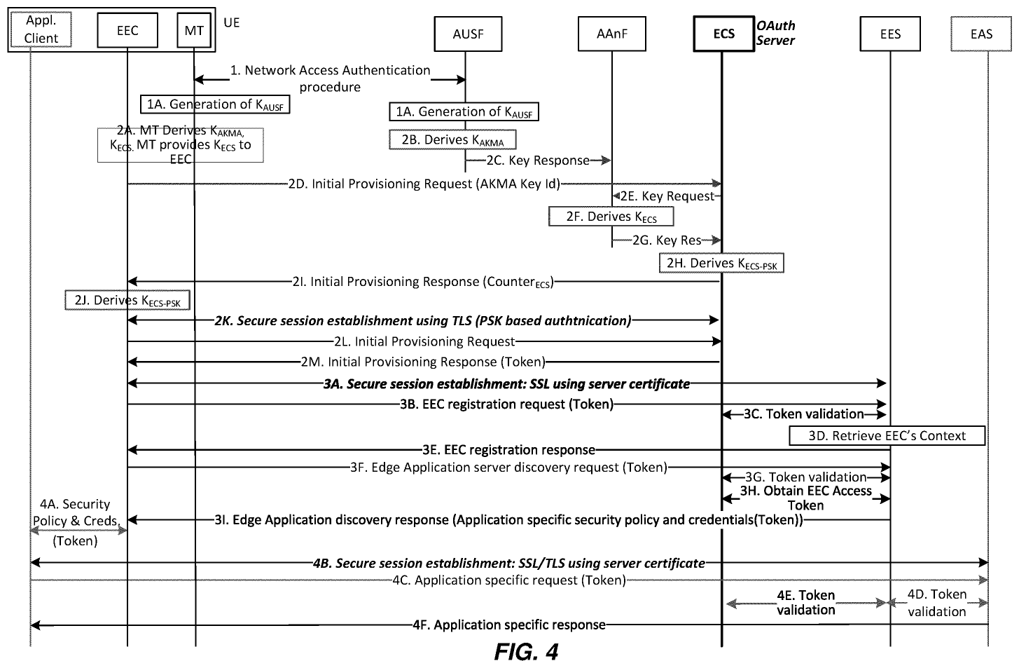

FIG. 4 shows an exemplary signal flow diagram of AKMA-based solution to address EEC authentication by ECS, which provides a token to EEC to be used for authentication with EES. A detailed description of this proposal (referred to as “solution #3”) is given in 3GPP TR 33.839 (v17.1.0) section 6.3.2, which is incorporated herein by reference in its entirety. 3GPP TR 33.839 section 6.4 describes a similar proposal (referred to as “solution #4) for using secondary authentication to address EEC authentication by the ECS, which provides a token to EEC to be used for authentication with EES.

3GPP TR 33.839 describes another proposal (referred to as “solution #17”) that involves tokens provided by an edge computing service provider (ECSP) that is associated with the EEC. For the EDGE-4 interface, the authentication of the ECS and the interface transport security are realized using TLS with server based on using the server's certificate issued by CAs in the PKI. For the first authentication of the EEC by the ECS, the token, including the EEC ID, provided by the ECSP of the EEC or by a trusted new entity (that could or could not be collocated with the ECSP) to the EEC is used. In the case of provisioning of a token by ECSP, it is assumed that there is a business relationship between the ECSPs of the EEC and ECS, whereby ECSP of the EEC provisions an initial access token to the EEC, and the ECS can verify that token. After EEC authentication, the ECS provides a token to the EEC in the initial access to be used for the next establishment of the communication between them. In the subsequent accesses after the initial access, the ECS decides on whether a new access token is necessary or not, considering information such as the expiration time of the token.

In solution #17, for the EDGE-1 interface, the authentication of the EES and the interface transport security are realized using TLS with server authentication based on the server's certificate issued by CAs in the PKI. For the authentication of the EEC by the EES, the EEC first gets a token from the ECS and sends the token to the EES. It is assumed that there is a business relationship between the ECSPs of the ECS and EES such that the EES can verify the token.

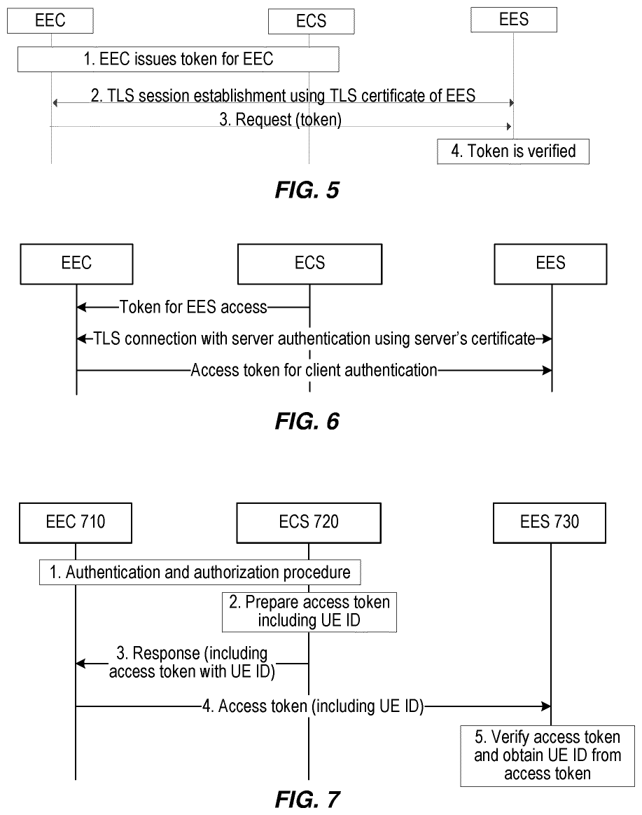

FIG. 5 shows an exemplary signal flow diagram of another proposal for authentication and authorization between EEC and EES. To summarize, TLS certificate of the EES is used for authentication of the EES by the EEC. EEC uses a token provided by ECS to authenticate itself towards to the EES. The token may be an access token (OAuth 2.0) for implicit authentication of the EEC or an identity token (OpenID Connect 1.0) for explicit authentication. Since there is a business relationship between the ECSPs of the EEC and ECS, the EES can verify the token.

In operation 1, ECS issues a token for the EEC to be used for authentication of the EEC by the EES. In operation 2, EEC and EES establish a TLS session using the TLS certificate of the EES. In operation 3, during the established TLS session, EEC sends the token provided by ECS. In operation 4, EES verifies the token.

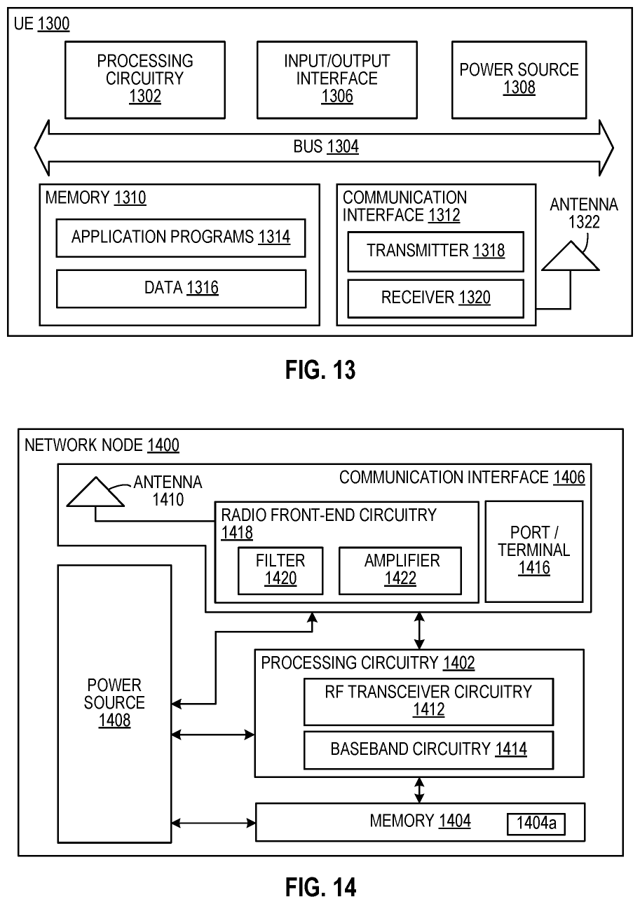

Other solutions for authentication of EEC towards to EES/ECS involve the service provider of EEC (i.e., ECSP) giving a token to EEC to be used for authentication of EEC by EES/ECS. FIG. 6 shows an exemplary signal flow diagram of one of these solutions for authentication on the EDGE-1 interface between EEC and EES. In this solution, the authentication of the EES and the transport security of the interface are realized by using TLS with server authentication using the server's (i.e., EES) certificate issued by CAs in PKI. As shown in FIG. 13, the ECS initially provides a token to the EEC. After setup of a TLS connection with server authentication using the EES certificate, the EEC uses the ECS-provided access token for EEC authentication with the EES.

As mentioned above, in addition to the EEC ID, the EEC also provides a UE ID for authentication towards EES/ECS. How EEC obtains the UE ID is not defined in 3GPP TS 23.558 or other specifications. One possible solution (called “solution 23”) is described in 3GPP TR 23.700-98 (v0.6.0). In solution 23, EEC invokes an EDGE UE ID service provided by EES.

Furthermore, it has not been specified how UE ID information is sent to EES. For example, 3GPP TS 23.558 states that whether the EEC ID and the UE ID are included in request of EDGE-1 and EDGE-4 interactions as part of the security credential is the responsibility of 3GPP group SA3, which has not yet defined or specified these requirements or details.

Embodiments of the present disclosure address these and other problems, issues, and/or difficulties by providing techniques whereby ECS provides the UE ID to EEC in the authentication and authorization procedure between the EEC and ECS. This information can be inserted into the access token if the EES uses access token based authorization, or this information can be sent in the response from the ECS to the EEC. Subsequently, EEC sends the UE ID received in this manner to EES during the authentication and authorization procedure between EEC and EES. Accordingly, embodiments provide clear and unambiguous ways for EEC to obtain and use a UE ID (i.e., of the UE hosting EEC) for authentication and authorization, thereby facilitating security of EC applications over 3GPP networks (e.g., 5GC and NG-RAN).

FIG. 7 shows a signaling diagram between an EEC (710), an ECS (720), and an EEC (730), according to some embodiments of the present disclosure. In particular, the procedure shown in FIG. 7 is for the scenario where EES supports EEC authorization based on access tokens. Although the operations in FIG. 7 are given numerical labels, this is done to facilitate explanation rather than to imply or require any operational order, unless stated to the contrary.

In operation 1, EEC and ECS perform a procedure for authentication and (optionally) authorization. During or after this procedure, ECS obtains a UE ID (e.g., GPSI) of the UE that hosts EEC, e.g., from the network using AKMA, GBA, or IP address-to-GPSI translation. Alternately, ECS can obtain the UE ID from its local configuration.

In operation 2, after a successful procedure in operation 1, ECS prepares an access token that includes the UE ID. For example, the access token can be an OAuth 2.0 token and the UE ID can be included in the subject claim of the token. Document RFC 7519 published by Internet Engineering Task Force (IETF) describes exemplary tokens with subject claim fields, in which the UE ID can be inserted.

In operation 3, ECS sends the access token including the UE ID in a response to the EEC. For example, the response may be a service provisioning response such as defined in 3GPP TS 23.558 section 8.3.3.3.3. In some embodiments, EEC may be implicitly aware that the access token received in the response from ECS includes the UE ID. In other embodiments, ECS can also include in the response an explicit indication that the UE ID is included in the access token. In either case, EEC does not need to use other mechanisms to obtain the UE ID, such as mechanisms described in 3GPP TR 23.700-98 (v0.6.0) section 7.23.

In operation 4, EEC sends the token, including the UE ID, to the EES for authentication and authorization. In operation 5, EES verifies the access token and obtains from the access token the UE ID of the UE that hosts the EEC.

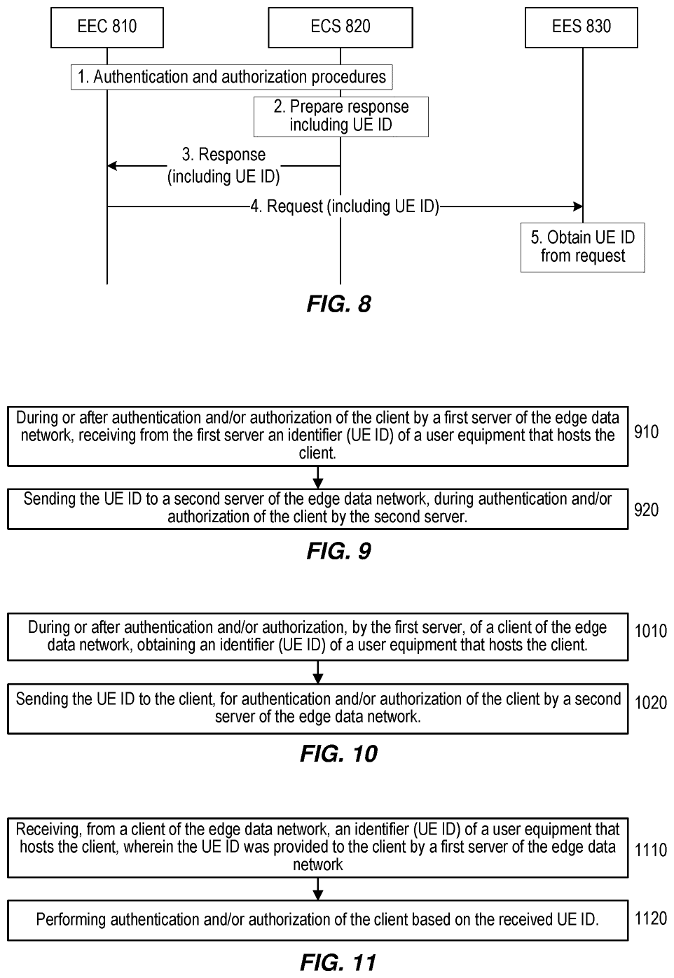

FIG. 8 shows a signaling diagram between an EEC (810), an ECS (820), and an EEC (830), according to other embodiments of the present disclosure. In particular, the procedure shown in FIG. 8 is for the scenario where EES does not support EEC authorization based on access tokens. Although the operations in FIG. 8 are given numerical labels, this is done to facilitate explanation rather than to imply or require any operational order, unless stated to the contrary.

In operation 1, EEC and ECS perform a procedure for authentication and (optionally) authorization. During or after this procedure, ECS obtains a UE ID (e.g., GPSI) of the UE that hosts EEC, e.g., from the network using AKMA, GBA, or IP address-to-GPSI translation. Alternately, ECS can obtain the UE ID from its local configuration.

In operation 2, after a successful procedure in operation 1, ECS prepares a response that includes the UE ID. In operation 3, ECS sends the response including the UE ID to the EEC. For example, the response may be a service provisioning response such as defined in 3GPP TS 23.558 section 8.3.3.3.3. In operation 4, EEC sends to the EES a request for authentication and authorization that includes the UE ID. In operation 5, EES obtains the UE ID from the received request, which it uses during authentication and authorization of the EEC.

The embodiments described above can be further illustrated with reference to FIGS. 9-11, which depict exemplary methods (e.g., procedures) performed by a client, a first server, and a second server of an edge data network, respectively. Put differently, various features of the operations described below correspond to various embodiments described above. The exemplary methods shown in FIGS. 9-11 can be complementary to each other such that they can be used cooperatively to provide benefits, advantages, and/or solutions to problems described herein. Although the exemplary methods are illustrated in FIGS. 9-11 by specific blocks in particular orders, the operations corresponding to the blocks can be performed in different orders than shown and can be combined and/or divided into operations having different functionality than shown. Optional blocks and/or operations are indicated by dashed lines.

More specifically, FIG. 9 illustrates an exemplary method (e.g., procedure) for a client of an edge data network (e.g., 5G network), according to various embodiments of the present disclosure. The exemplary method shown in FIG. 9 can be performed by a client hosted by a UE (e.g., wireless device), such as an EEC described elsewhere herein.

The exemplary method can include the operations of block 910, where during or after authentication and/or authorization of the client by a first server of the edge data network, the client can receive from the first server an identifier (UE ID) of a user equipment that hosts the client. The exemplary method can also include the operations of block 920, where the client can send the UE ID to a second server of the edge data network, during authentication and/or authorization of the client by the second server.

In some embodiments, the UE ID is included in an access token received from the first server (e.g., in block 910) and the access token including the UE ID is sent to the second server (e.g., in block 920). FIG. 7 shows an example of these embodiments. In some of these embodiments, one of more of the following applies:
the access token is sent to the second server together with an indication that the access token includes the UE ID; and
the access token is received from the first server together with an indication that the access token includes the UE ID.

In other embodiments, the UE ID is received from the first server in a service provisioning response, which does not include an access token for the second server; and/or the UE ID is sent to the second server in a request that does not include an access token for the second server. FIG. 8 shows an example of these embodiments.

In some embodiments, the client is an EEC, the first server is an ECS, and the second server is an EES. In some embodiments, the UE ID is a GPSI.

In addition, FIG. 10 illustrates an exemplary method (e.g., procedure) for a first server of an edge data network (e.g., 5G network), according to various embodiments of the present disclosure. The exemplary method shown in FIG. 10 can be performed by any appropriate server (e.g., ECS, etc.) such as described elsewhere herein.

The exemplary method can include the operation of block 1010, where during or after authentication and/or authorization, by the first server, of a client of the edge data network, the first server can obtain an identifier (UE ID) of a user equipment that hosts the client. The exemplary method can include the operation of block 1020, where the first server can send the UE ID to the client, for authentication and/or authorization of the client by a second server of the edge data network.

In some embodiments, the UE ID is a GPSI and is obtained (e.g., in block 1010) based on one of the following:
an authentication and key management for applications (AKMA) procedure with a communication network coupled to the edge data network;
a generic bootstrapping architecture (GBA) procedure with the communication network; or
an IP address-to-GPSI translation.

In some embodiments, the UE ID is sent to the client in an access token for the second server. FIG. 7 shows an example of these embodiments. In some of these embodiments, the access token is included in a service provisioning response to the client. In some of these embodiments, the access token is sent to the client together with an indication that the access token includes the UE ID.

In other embodiments, the UE ID is sent to the client in a service provisioning response, which does not include an access token for the second server. FIG. 8 shows an example of these embodiments.

In some embodiments, the client is an EEC, the first server is an ECS, and the second server is an EES.

In addition, FIG. 11 illustrates an exemplary method (e.g., procedure) for a second server of an edge data network (e.g., 5G network), according to various embodiments of the present disclosure. The exemplary method shown in FIG. 11 can be performed by any appropriate server (e.g., EES, etc.) such as described elsewhere herein.

The exemplary method can include the operations of block 1110, where the second server can receive, from a client of the edge data network, an identifier (UE ID) of a user equipment that hosts the client. The UE ID was provided to the client by a first server of the edge data network. The exemplary method can also include the operations of block 1120, where the second server can perform authentication and/or authorization of the client based on the received UE ID.

In some embodiments, the UE ID is received from the client in in access token for the second server, the access token is generated by the first server, and authentication and/or authorization of the client is performed based on the access token. FIG. 7 shows an example of these embodiments. In some of these embodiments, the access token is received from the client together with an indication that the access token includes the UE ID.

In other embodiments, the UE ID is received from the client in a request that does not include an access token for the second server. FIG. 8 shows an example of these embodiments.

In some embodiments, the client is an EEC and the second server is an EES. In some embodiments, the UE ID is a GPSI.

Although various embodiments are described above in terms of methods, techniques, and/or procedures, the person of ordinary skill will readily comprehend that such methods, techniques, and/or procedures can be embodied by various combinations of hardware and software in various systems, communication devices, computing devices, control devices, apparatuses, non-transitory computer-readable media, computer program products, etc.

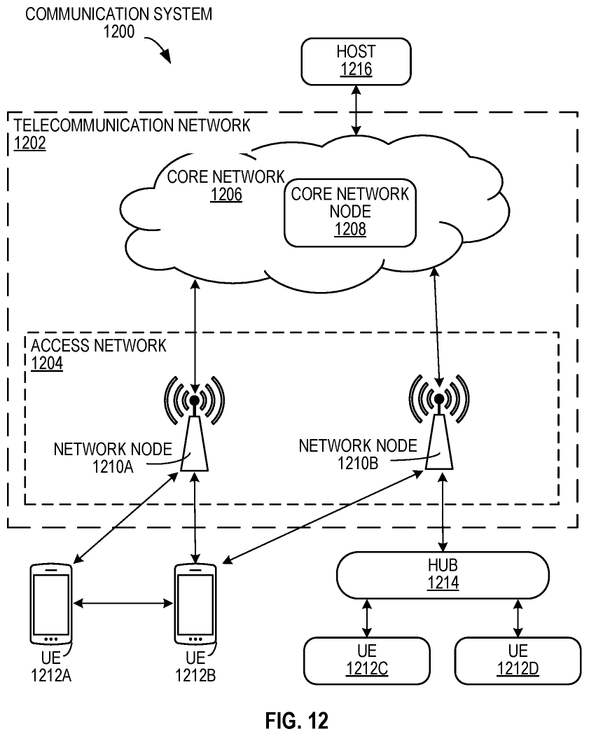

FIG. 12 shows an example of a communication system 1200 in accordance with some embodiments. In this example, communication system 1200 includes a telecommunication network 1202 that includes an access network 1204 (e.g., RAN) and a core network 1206, which includes one or more core network nodes 1208. Access network 1204 includes one or more access network nodes, such as network nodes 1210a-b (one or more of which may be generally referred to as network nodes 1210), or any other similar 3GPP access node or non-3GPP access point. Network nodes 1210 facilitate direct or indirect connection of UEs, such as by connecting UEs 1212a-d (one or more of which may be generally referred to as UEs 1212) to core network 1206 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, communication system 1200 may include any number of wired or wireless networks, network nodes, UEs, and/or any other components or systems that may facilitate or participate in the communication of data and/or signals whether via wired or wireless connections. Communication system 1200 may include and/or interface with any type of communication, telecommunication, data, cellular, radio network, and/or other similar type of system.

UEs 1212 may be any of a wide variety of communication devices, including wireless devices arranged, configured, and/or operable to communicate wirelessly with network nodes 1210 and other communication devices. Similarly, network nodes 1210 are arranged, capable, configured, and/or operable to communicate directly or indirectly with UEs 1212 and/or with other network nodes or equipment in telecommunication network 1202 to enable and/or provide network access, such as wireless network access, and/or to perform other functions, such as administration in telecommunication network 1202.

In the depicted example, core network 1206 connects network nodes 1210 to one or more hosts, such as host 1216. These connections may be direct or indirect via one or more intermediary networks or devices. In other examples, network nodes may be directly coupled to hosts. Core network 1206 includes one or more core network nodes (e.g., 1208) that are structured with hardware and software components. Features of these components may be substantially similar to those described with respect to the UEs, network nodes, and/or hosts, such that the descriptions thereof are generally applicable to the corresponding components of core network node 1208. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

Host 1216 may be under the ownership or control of a service provider other than an operator or provider of access network 1204 and/or telecommunication network 1202, and may be operated by the service provider or on behalf of the service provider. Host 1216 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, communication system 1200 of FIG. 12 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, telecommunication network 1202 is a cellular network that implements 3GPP standardized features. Accordingly, telecommunication network 1202 may support network slicing to provide different logical networks to different devices that are connected to telecommunication network 1202. For example, telecommunication network 1202 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

As another example, communication system 1200 can include an edge data network. In such case, various servers of the edge data network can be part of telecommunication network 1202, e.g., hosted or implemented by one or more core network nodes 1208 and/or one or more network nodes 1210. Furthermore, UE 1212 can implement or host one or more clients for the edge data network. As such, the clients and servers hosted by communication system 1200 can perform operations attributed to these entities in the above descriptions of various methods or procedures.

In some examples, UEs 1212 are configured to transmit and/or receive information without direct human interaction. For instance, a UE may be designed to transmit information to access network 1204 on a predetermined schedule, when triggered by an internal or external event, or in response to requests from access network 1204. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, hub 1214 communicates with access network 1204 to facilitate indirect communication between one or more UEs (e.g., 1212c and/or 1212d) and network nodes (e.g., 1210b). In some examples, hub 1214 may be a controller, router, content source and analytics, or any of the other communication devices described herein regarding UEs. For example, hub 1214 may be a broadband router enabling access to core network 1206 for the UEs. As another example, hub 1214 may be a controller that sends commands or instructions to one or more actuators in the UEs. Commands or instructions may be received from the UEs, network nodes 1210, or by executable code, script, process, or other instructions in hub 1214. As another example, hub 1214 may be a data collector that acts as temporary storage for UE data and, in some embodiments, may perform analysis or other processing of the data. As another example, hub 1214 may be a content source. For example, for a UE that is a VR headset, display, loudspeaker or other media delivery device, hub 1214 may retrieve VR assets, video, audio, or other media or data related to sensory information via a network node, which hub 1214 then provides to the UE either directly, after performing local processing, and/or after adding additional local content. In still another example, hub 1214 acts as a proxy server or orchestrator for the UEs, in particular in if one or more of the UEs are low energy IoT devices.

Hub 1214 may have a constant/persistent or intermittent connection to network node 1210b. Hub 1214 may also allow for a different communication scheme and/or schedule between hub 1214 and UEs (e.g., UE 1212c and/or 1212d), and between hub 1214 and core network 1206. In other examples, hub 1214 is connected to core network 1206 and/or one or more UEs via a wired connection. Moreover, hub 1214 may be configured to connect to an M2M service provider over access network 1204 and/or to another UE over a direct connection. In some scenarios, UEs may establish a wireless connection with network nodes 1210 while still connected via hub 1214 via a wired or wireless connection. In some embodiments, hub 1214 may be a dedicated hub—that is, a hub whose primary function is to route communications to/from the UEs from/to network node 1210b. In other embodiments, hub 1214 may be a non-dedicated hub—that is, a device which is capable of operating to route communications between the UEs and network node 1210b, but which is additionally capable of operating as a communication start and/or end point for certain data channels.

FIG. 13 shows a UE 1300 in accordance with some embodiments. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by 3GPP, including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

UE 1300 includes processing circuitry 1302 that is operatively coupled via bus 1304 to input/output interface 1306, power source 1308, memory 1310, communication interface 1312, and/or any other component, or any combination thereof. Certain UEs may utilize all or a subset of the components shown in FIG. 13. The level of integration between the components may vary from one UE to another UE. Further, certain UEs may contain multiple instances of a component, such as multiple processors, memories, transceivers, transmitters, receivers, etc.

Processing circuitry 1302 is configured to process instructions and data and may be configured to implement any sequential state machine operative to execute instructions stored as machine-readable computer programs in memory 1310. Processing circuitry 1302 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, processing circuitry 1302 may include multiple central processing units (CPUs).

In the example, input/output interface 1306 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into UE 1300. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, power source 1308 is structured as a battery or battery pack. Other types of power sources, such as an external power source (e.g., an electricity outlet), photovoltaic device, or power cell, may be used. Power source 1308 may further include power circuitry for delivering power from power source 1308 itself, and/or an external power source, to the various parts of UE 1300 via input circuitry or an interface such as an electrical power cable. Delivering power may be, for example, for charging power source 1308. Power circuitry may perform any formatting, converting, or other modification to the power from power source 1308 to make the power suitable for the respective components of UE 1300 to which power is supplied.

Memory 1310 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, memory 1310 includes one or more application programs 1314, such as an operating system, web browser application, a widget, gadget engine, or other application, and corresponding data 1316. Memory 1310 may store, for use by UE 1300, any of a variety of various operating systems or combinations of operating systems.

Memory 1310 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ Memory 1310 may allow UE 1300 to access instructions, application programs and the like, stored on transitory or non-transitory memory media, to off-load data, or to upload data. An article of manufacture, such as one utilizing a communication system may be tangibly embodied as or in memory 1310, which may be or comprise a device-readable storage medium.

Processing circuitry 1302 may be configured to communicate with an access network or other network using communication interface 1312. Communication interface 1312 may comprise one or more communication subsystems and may include or be communicatively coupled to an antenna 1322. Communication interface 1312 may include one or more transceivers used to communicate, such as by communicating with one or more remote transceivers of another device capable of wireless communication (e.g., another UE or a network node in an access network). Each transceiver may include transmitter 1318 and/or receiver 1320 appropriate to provide network communications (e.g., optical, electrical, frequency allocations, and so forth). Moreover, transmitter 1318 and receiver 1320 may be coupled to one or more antennas (e.g., 1322) and may share circuit components, software or firmware, or alternatively be implemented separately.

In the illustrated embodiment, communication functions of communication interface 1312 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1312, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., an alert is sent when moisture is detected), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to UE 1300 shown in FIG. 13.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

As another specific example, UE 1300 can implement or host one or more clients for an edge data network, such as an EEC. In such case, UE 1300 can perform operations attributed to such clients in various methods or procedures described above.

In practice, any number of UEs may be used together with respect to a single use case. For example, a first UE might be or be integrated in a drone and provide the drone's speed information (obtained through a speed sensor) to a second UE that is a remote controller operating the drone.

When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 14 shows a network node 1400 in accordance with some embodiments. Examples of network nodes include, but are not limited to, access points (e.g., radio access points) and base stations (e.g., radio base stations, Node Bs, eNBs, and gNBs).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

As another specific example, various servers of an edge data network (e.g., ECS and/or EES) can be implemented or hosted by one or more network nodes 1400. In such case, each of these network nodes 1400 can perform operations attributed to such servers in various methods or procedures described above.

Network node 1400 includes processing circuitry 1402, memory 1404, communication interface 1406, and power source 1408. Network node 1400 may be composed of multiple physically separate components (e.g., a NodeB component and a RNC component, or a BTS component and a BSC component, etc.), which may each have their own respective components. In certain scenarios in which network node 1400 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, network node 1400 may be configured to support multiple radio access technologies (RATs). In such embodiments, some components may be duplicated (e.g., separate memory 1404 for different RATs) and some components may be reused (e.g., an antenna 1410 may be shared by different RATs). Network node 1400 may also include multiple sets of the various illustrated components for different wireless technologies integrated into network node 1400, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1400.

Processing circuitry 1402 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1400 components, such as memory 1404, to provide network node 1400 functionality.

In some embodiments, processing circuitry 1402 includes a system on a chip (SOC). In some embodiments, processing circuitry 1402 includes one or more of radio frequency (RF) transceiver circuitry 1412 and baseband processing circuitry 1414. In some embodiments, RF transceiver circuitry 1412 and baseband processing circuitry 1414 may be on separate chips (or sets of chips), boards, or units, such as radio units and digital units. In alternative embodiments, part or all of RF transceiver circuitry 1412 and baseband processing circuitry 1414 may be on the same chip or set of chips, boards, or units.

Memory 1404 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by processing circuitry 1402. Memory 1404 may store any suitable instructions, data, or information, including a computer program, software, an application including one or more of logic, rules, code, tables, and/or other instructions (collectively denoted computer program 1404a, which may be in the form of a computer program product) capable of being executed by processing circuitry 1402 and utilized by network node 1400. Memory 1404 may be used to store any calculations made by processing circuitry 1402 and/or any data received via communication interface 1406. In some embodiments, processing circuitry 1402 and memory 1404 is integrated.

Communication interface 1406 is used in wired or wireless communication of signaling and/or data between a network node, access network, and/or UE. As illustrated, communication interface 1406 comprises port(s)/terminal(s) 1416 to send and receive data, for example to and from a network over a wired connection. Communication interface 1406 also includes radio front-end circuitry 1418 that may be coupled to, or in certain embodiments a part of, antenna 1410. Radio front-end circuitry 1418 comprises filters 1420 and amplifiers 1422. Radio front-end circuitry 1418 may be connected to an antenna 1410 and processing circuitry 1402. The radio front-end circuitry may be configured to condition signals communicated between antenna 1410 and processing circuitry 1402. Radio front-end circuitry 1418 may receive digital data that is to be sent out to other network nodes or UEs via a wireless connection. Radio front-end circuitry 1418 may convert the digital data into a radio signal having the appropriate channel and bandwidth parameters using a combination of filters 1420 and/or amplifiers 1422. The radio signal may then be transmitted via antenna 1410. Similarly, when receiving data, antenna 1410 may collect radio signals which are then converted into digital data by radio front-end circuitry 1418. The digital data may be passed to processing circuitry 1402. In other embodiments, the communication interface may comprise different components and/or different combinations of components.

In certain alternative embodiments, network node 1400 does not include separate radio front-end circuitry 1418, instead, processing circuitry 1402 includes radio front-end circuitry and is connected to antenna 1410. Similarly, in some embodiments, all or some of RF transceiver circuitry 1412 is part of communication interface 1406. In still other embodiments, communication interface 1406 includes one or more ports or terminals 1416, radio front-end circuitry 1418, and RF transceiver circuitry 1412, as part of a radio unit (not shown), and communication interface 1406 communicates with baseband processing circuitry 1414, which is part of a digital unit (not shown).

Antenna 1410 may include one or more antennas, or antenna arrays, configured to send and/or receive wireless signals. Antenna 1410 may be coupled to radio front-end circuitry 1418 and may be any type of antenna capable of transmitting and receiving data and/or signals wirelessly. In certain embodiments, antenna 1410 is separate from network node 1400 and connectable to network node 1400 through an interface or port.

Antenna 1410, communication interface 1406, and/or processing circuitry 1402 may be configured to perform any receiving operations and/or certain obtaining operations described herein as being performed by the network node. Any information, data and/or signals may be received from a UE, another network node and/or any other network equipment. Similarly, antenna 1410, communication interface 1406, and/or processing circuitry 1402 may be configured to perform any transmitting operations described herein as being performed by the network node. Any information, data and/or signals may be transmitted to a UE, another network node and/or any other network equipment.

Power source 1408 provides power to the various components of network node 1400 in a form suitable for the respective components (e.g., at a voltage and current level needed for each respective component). Power source 1408 may further comprise, or be coupled to, power management circuitry to supply the components of network node 1400 with power for performing the functionality described herein. For example, network node 1400 may be connectable to an external power source (e.g., the power grid, an electricity outlet) via an input circuitry or interface such as an electrical cable, whereby the external power source supplies power to power circuitry of power source 1408. As a further example, power source 1408 may comprise a source of power in the form of a battery or battery pack which is connected to, or integrated in, power circuitry. The battery may provide backup power should the external power source fail.

Embodiments of network node 1400 may include additional components beyond those shown in FIG. 14 for providing certain aspects of the network node's functionality, including any of the functionality described herein and/or any functionality necessary to support the subject matter described herein. For example, network node 1400 may include user interface equipment to allow input of information into network node 1400 and to allow output of information from network node 1400. This may allow a user to perform diagnostic, maintenance, repair, and other administrative functions for network node 1400.

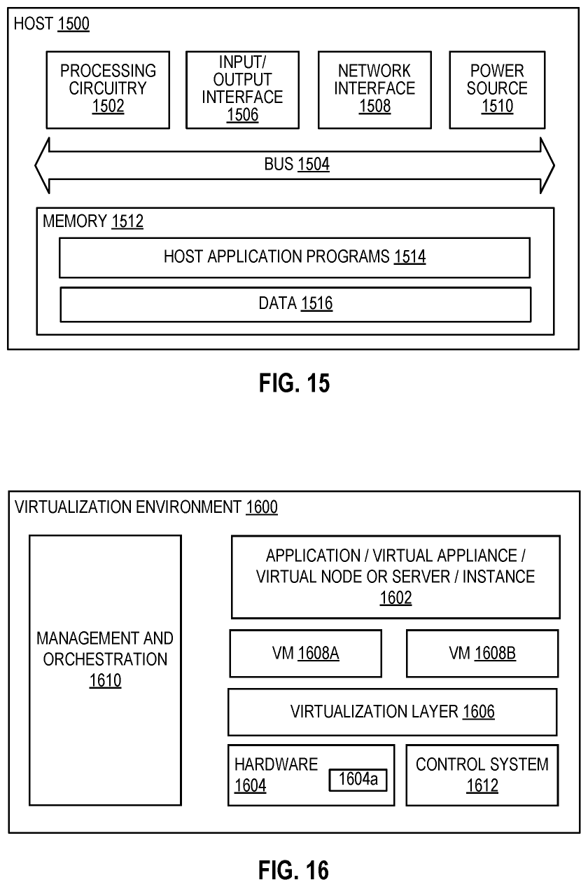

FIG. 15 is a block diagram of a host 1500, which may be an embodiment of host 1216 of FIG. 12, in accordance with various aspects described herein. As used herein, host 1500 may be or comprise various combinations hardware and/or software, including a standalone server, a blade server, a cloud-implemented server, a distributed server, a virtual machine, container, or processing resources in a server farm. Host 1500 may provide one or more services to one or more UEs. As a specific example, host 1600 can implement one or more servers of an edge data network (e.g., ECS and/or EES), including performing various exemplary methods attributed to such servers in the description above.

Host 1500 includes processing circuitry 1502 that is operatively coupled via a bus 1504 to an input/output interface 1506, a network interface 1508, a power source 1510, and a memory 1512. Other components may be included in other embodiments. Features of these components may be substantially similar to those described with respect to the devices of previous figures, such as FIGS. 13 and 14, such that the descriptions thereof are generally applicable to the corresponding components of host 1500.

Memory 1512 may include one or more computer programs including one or more host application programs 1514 and data 1516, which may include user data, e.g., data generated by a UE for host 1500 or data generated by host 1500 for a UE. Embodiments of host 1500 may utilize all or only a subset of the components shown. Host application programs 1514 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). Host application programs 1514 may also provide for user authentication and licensing checks and may periodically report health, routes, and content availability to a central node, such as a device in or on the edge of a core network. Accordingly, host 1500 may select and/or indicate a different host for over-the-top services for a UE. Host application programs 1514 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 16 is a block diagram illustrating a virtualization environment 1600 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1600 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1602 (which may alternatively be called software instances, virtual appliances, network functions, virtual nodes, virtual network functions, etc.) are run in the virtualization environment 1600 to implement some of the features, functions, and/or benefits of some of the embodiments disclosed herein. As a specific example, various servers of an edge data network (e.g., ECS and/or EES) described above can be implemented in virtualization environment 1600 as applications, software instances, virtual appliances, network functions, virtual nodes, virtual network functions, etc.

Hardware 1604 includes processing circuitry, memory that stores software and/or instructions (collectively denoted computer program 1604a, which may be in the form of a computer program product) executable by hardware processing circuitry, and/or other hardware devices as described herein, such as a network interface, input/output interface, and so forth. Software may be executed by the processing circuitry to instantiate one or more virtualization layers 1606 (also referred to as hypervisors or virtual machine monitors (VMMs)), provide VMs 1608a-b (one or more of which may be generally referred to as VMs 1608), and/or perform any of the functions, features and/or benefits described in relation with some embodiments described herein. The virtualization layer 1606 may present a virtual operating platform that appears like networking hardware to the VMs 1608.

VMs 1608 comprise virtual processing, virtual memory, virtual networking or interface and virtual storage, and may be run by a corresponding virtualization layer 1606. Different embodiments of the instance of a virtual appliance 1602 may be implemented on one or more of VMs 1608, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, each VM 1608 may be a software implementation of a physical machine that runs programs as if they were executing on a physical, non-virtualized machine. Each VM 1608, and that part of hardware 1604 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1608 on top of the hardware 1604 and corresponds to application 1602.

Hardware 1604 may be implemented in a standalone network node with generic or specific components. Hardware 1604 may implement some functions via virtualization. Alternatively, hardware 1604 may be part of a larger cluster of hardware (e.g., such as in a data center or CPE) where many hardware nodes work together and are managed via management and orchestration 1610, which, among others, oversees lifecycle management of applications 1602. In some embodiments, hardware 1604 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of control system 1612 which may alternatively be used for communication between hardware nodes and radio units.

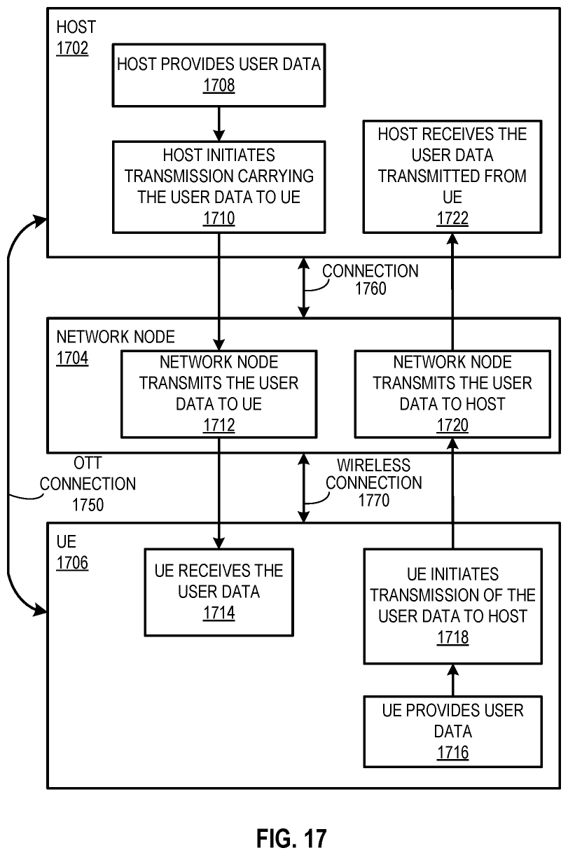

FIG. 17 shows a communication diagram of a host 1702 communicating via a network node 1704 with a UE 1706 over a partially wireless connection in accordance with some embodiments. Example implementations, in accordance with various embodiments, of the UE (such as a UE 1212a of FIG. 12 and/or UE 1300 of FIG. 13), network node (such as network node 1210a of FIG. 12 and/or network node 1400 of FIG. 14), and host (such as host 1216 of FIG. 12 and/or host 1500 of FIG. 15) discussed in the preceding paragraphs will now be described with reference to FIG. 17.

Like host 1500, embodiments of host 1702 include hardware, such as a communication interface, processing circuitry, and memory. Host 1702 also includes software, which is stored in or accessible by host 1702 and executable by the processing circuitry. The software includes a host application that may be operable to provide a service to a remote user, such as UE 1706 connecting via an over-the-top (OTT) connection 1750 extending between UE 1706 and host 1702. In providing the service to the remote user, a host application may provide user data which is transmitted using OTT connection 1750.

Network node 1704 includes hardware enabling it to communicate with host 1702 and UE 1706. Connection 1760 may be direct or pass through a core network (like core network 1206 of FIG. 12) and/or one or more other intermediate networks, such as one or more public, private, or hosted networks. For example, an intermediate network may be a backbone network or the Internet.

UE 1706 includes hardware and software, which is stored in or accessible by UE 1706 and executable by the UE's processing circuitry. The software includes a client application, such as a web browser or operator-specific “app” that may be operable to provide a service to a human or non-human user via UE 1706 with the support of host 1702. In host 1702, an executing host application may communicate with the executing client application via OTT connection 1750 terminating at UE 1706 and host 1702. In providing the service to the user, the UE's client application may receive request data from the host's host application and provide user data in response to the request data. OTT connection 1750 may transfer both the request data and the user data. The UE's client application may interact with the user to generate the user data that it provides to the host application through OTT connection 1750.

OTT connection 1750 may extend via a connection 1760 between host 1702 and network node 1704 and via a wireless connection 1770 between network node 1704 and UE 1706 to provide the connection between host 1702 and UE 1706. Connection 1760 and wireless connection 1770, over which OTT connection 1750 may be provided, have been drawn abstractly to illustrate the communication between host 1702 and UE 1706 via network node 1704, without explicit reference to any intermediary devices and the precise routing of messages via these devices.

As an example of transmitting data via OTT connection 1750, in step 1708, host 1702 provides user data, which may be performed by executing a host application. In some embodiments, the user data is associated with a particular human user interacting with UE 1706. In other embodiments, the user data is associated with a UE 1706 that shares data with host 1702 without explicit human interaction. In step 1710, host 1702 initiates a transmission carrying the user data towards UE 1706. Host 1702 may initiate the transmission responsive to a request transmitted by UE 1706. The request may be caused by human interaction with UE 1706 or by operation of the client application executing on UE 1706. The transmission may pass via network node 1704, in accordance with the teachings of the embodiments described throughout this disclosure. Accordingly, in step 1712, network node 1704 transmits to UE 1706 the user data that was carried in the transmission that host 1702 initiated, in accordance with the teachings of the embodiments described throughout this disclosure. In step 1714, UE 1706 receives the user data carried in the transmission, which may be performed by a client application executed on UE 1706 associated with the host application executed by host 1702.

In some examples, UE 1706 executes a client application which provides user data to host 1702. The user data may be provided in reaction or response to the data received from host 1702. Accordingly, in step 1716, UE 1706 may provide user data, which may be performed by executing the client application. In providing the user data, the client application may further consider user input received from the user via an input/output interface of UE 1706. Regardless of the specific manner in which the user data was provided, UE 1706 initiates, in step 1718, transmission of the user data towards host 1702 via network node 1704. In step 1720, in accordance with the teachings of the embodiments described throughout this disclosure, network node 1704 receives user data from UE 1706 and initiates transmission of the received user data towards host 1702. In step 1722, host 1702 receives the user data carried in the transmission initiated by UE 1706.

One or more of the various embodiments improve the performance of OTT services provided to UE 1706 using OTT connection 1750, in which wireless connection 1770 forms the last segment. More precisely, embodiments described herein can provide clear and unambiguous ways for an EEC to obtain and use a UE ID (i.e., GPSI of the UE hosting EEC) for authentication and authorization, thereby facilitating security of EC applications over 3GPP networks (e.g., 5GC and NG-RAN). When edge computing deployed in this manner is used to provide and/or support OTT data services, it increases the value of such services to end users and service providers.

In an example scenario, factory status information may be collected and analyzed by host 1702. As another example, host 1702 may process audio and video data which may have been retrieved from a UE for use in creating maps. As another example, host 1702 may collect and analyze real-time data to assist in controlling vehicle congestion (e.g., controlling traffic lights). As another example, host 1702 may store surveillance video uploaded by a UE. As another example, host 1702 may store or control access to media content such as video, audio, VR or AR which it can broadcast, multicast or unicast to UEs. As other examples, host 1702 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring OTT connection 1750 between host 1702 and UE 1706, in response to variations in the measurement results. The measurement procedure and/or the network functionality for reconfiguring the OTT connection may be implemented in software and hardware of host 1702 and/or UE 1706. In some embodiments, sensors (not shown) may be deployed in or in association with other devices through which OTT connection 1750 passes; the sensors may participate in the measurement procedure by supplying values of the monitored quantities exemplified above, or supplying values of other physical quantities from which software may compute or estimate the monitored quantities. The reconfiguring of OTT connection 1750 may include message format, retransmission settings, preferred routing etc.; the reconfiguring need not directly alter the operation of network node 1704. Such procedures and functionalities may be known and practiced in the art. In certain embodiments, measurements may involve proprietary UE signaling that facilitates measurements of throughput, propagation times, latency and the like, by host 1702. The measurements may be implemented in that software causes messages to be transmitted, in particular empty or ‘dummy’ messages, using OTT connection 1750 while monitoring propagation times, errors, etc.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various exemplary embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according to one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously.

1.-38. (canceled)

39. A method for a client configured to operate in an edge data network, the method comprising:
during or after authentication and/or authorization of the client by a first server in the edge data network, receiving from the first server an identifier (UE ID) of a user equipment that hosts the client; and
sending the UE ID to a second server in the edge data network, during authentication and/or authorization of the client by the second server.

40. The method of claim 39, wherein:
the UE ID is included in an access token received from the first server; and
the access token including the UE ID is sent to the second server.

41. The method of claim 40, wherein the access token is included in a service provisioning response from the first server.

42. The method of claim 40, wherein one of more of the following applies:
the access token is sent to the second server together with an indication that the access token includes the UE ID; and
the access token is received from the first server together with an indication that the access token includes the UE ID.

43. The method of claim 39, wherein one or more of the following applies:
the UE ID is received from the first server in a service provisioning response, which does not include an access token for the second server; and
the UE ID is sent to the second server in a request that does not include an access token for the second server.

44. The method of claim 39, wherein the client is an Edge Enabler Client (EEC), the first server is an Edge Configuration Server (ECS), and the second server is an Edge Enabler Server (EES).

45. The method of claim 39, wherein the UE ID is a generic public subscription identifier (GPSI).

46. A method for a first server configured to operate in an edge data network, the method comprising:
during or after authentication and/or authorization by the first server of a client in the edge data network, obtaining an identifier (UE ID) of a user equipment that hosts the client; and
sending the UE ID to the client, for authentication and/or authorization of the client by a second server in the edge data network.

47. The method of claim 46, wherein the UE ID is a generic public subscription identifier (GPSI), and is obtained based on one of the following:
an authentication and key management for applications (AKMA) procedure with a communication network coupled to the edge data network;
a generic bootstrapping architecture (GBA) procedure with the communication network; or
an Internet Protocol (IP) address-to-GPSI translation.

48. The method of claim 46, wherein the UE ID is sent to the client in an access token for the second server.

49. The method of claim 48, wherein one or more of the following applies:
the access token is included in a service provisioning response to the client; and
the access token is sent to the client together with an indication that the access token includes the UE ID.

50. The method of claim 46, wherein the UE ID is sent to the client in a service provisioning response, which does not include an access token for the second server.

51. The method of claim 46, wherein the client is an Edge Enabler Client (EEC), the first server is an Edge Configuration Server (ECS), and the second server is an Edge Enabler Server (EES).

52. A method for a second server configured to operate in an edge data network, the method comprising:
receiving, from a client of the edge data network, an identifier (UE ID) of a user equipment that hosts the client, wherein the UE ID was provided to the client by a first server in the edge data network; and
performing authentication and/or authorization of the client based on the received UE ID.

53. The method of claim 52, wherein:
the UE ID is received from the client in in access token for the second server;
the access token is generated by the first server; and
authentication and/or authorization of the client is performed based on the access token.

54. The method of claim 53, wherein the access token is received from the client together with an indication that the access token includes the UE ID.

55. The method of claim 52, wherein the UE ID is received from the client in a request that does not include an access token for the second server.

56. The method of claim 52, wherein the client is an Edge Enabler Client (EEC), the first server is an Edge Configuration Server (ECS), and the second server is an Edge Enabler Server (EES).

57. The method of claim 52, wherein the UE ID is a generic public subscription identifier (GPSI).

58. User equipment (UE) arranged to host a client configured to operate in an edge data network, the UE comprising:
communication interface circuitry configured to facilitate communication between the client and first and second servers in the edge data network; and
processing circuitry operably coupled to the communication interface circuitry, wherein the processing circuitry and communication interface circuitry are configured to:
during or after authentication and/or authorization of the client by a first server in the edge data network, receive from the first server an identifier of the UE (UE ID); and
send the UE ID to a second server in the edge data network, during authentication and/or authorization of the client by the second server.

59. The UE of claim 58, wherein:
the UE ID is included in an access token received from the first server; and
the access token including the UE ID is sent to the second server.

60. The UE of claim 58, wherein one or more of the following applies:
the UE ID is received from the first server in a service provisioning response, which does not include an access token for the second server; and
the UE ID is sent to the second server in a request that does not include an access token for the second server.

61. A first server configured to operate in an edge data network, the first server comprising:
communication interface circuitry configured to communicate with one or more clients of the edge data network; and
processing circuitry operably coupled to the interface circuitry, wherein the processing circuitry and the communication interface circuitry are configured to:
during or after authentication and/or authorization by the first server of a client in the edge data network, obtain an identifier (UE ID) of a user equipment that hosts the client; and
send the UE ID to the client, for authentication and/or authorization of the client by a second server in the edge data network.

62. The first server of claim 61, wherein one of the following applies:
the UE ID is sent to the client in an access token for the second server; or
the UE ID is sent to the client in a service provisioning response, which does not include an access token for the second server.

63. A second server configured to operate in an edge data network, the second server comprising:
communication interface circuitry configured to communicate with one or more clients of the edge data network; and
processing circuitry operably coupled to the interface circuitry, wherein the processing circuitry and the communication interface circuitry are configured to:
receive, from a client of the edge data network, an identifier (UE ID) of a user equipment that hosts the client, wherein the UE ID was provided to the client by a first server in the edge data network; and
perform authentication and/or authorization of the client based on the received UE ID.

64. The second server of claim 63, wherein one of the following applies:
the UE ID is received from the client in in access token for the second server, the access token is generated by the first server, and authentication and/or authorization of the client is performed based on the access token; or
the UE ID is received from the client in a request that does not include an access token for the second server.
